(19) United States
(12) Patent Application Publication
(10) Pub. No.: US 2024/0103392 A1
(43) Pub. Date: Mar. 28, 2024

(54) DEVELOPING DEVICE CONTACT AND SEPARATION MECHANISM THAT SWITCHES CONTACTING AND SEPARATED STATE BETWEEN DEVELOPING ROLLER AND PHOTOCONDUCTOR DRUM, AND IMAGE FORMING APPARATUS

(71) Applicant: KYOCERA Document Solutions Inc., Osaka (JP)

(72) Inventors: Takeshi YOSHIDA, Osaka (JP); Teruhiko NAGASHIMA, Osaka (JP); Hirotaka ISHIDA, Osaka (JP)

(73) Assignee: KYOCERA Document Solutions Inc., Osaka (JP)

(21) Appl. No.: 18/369,931

(22) Filed: Sep. 19, 2023

(30) Foreign Application Priority Data
Sep. 28, 2022 (JP) 2022-155086

(51) Int. Cl. G03G 15/01

(52) U.S. Cl. CPC G03G 15/0121

(57) ABSTRACT

A developing device contact and separation mechanism includes a monochrome operating member, a color operating member, and a rotating member that rotates among a first position for a non-operational state, a second position for color printing, and a third position for monochrome printing. At the first position, the rotating member moves the monochrome developing device to the separated position, via the monochrome operating member, and the color developing device to the separated position, via the color operating member. At the second position, the rotating member moves the monochrome developing device to the contacting position, via the monochrome operating member, and the color developing device to the contacting position, via the color operating member. At the third position, the rotating member moves the monochrome developing device to the contacting position, via the monochrome operating member, and the color developing device to the separated position, via the color operating member.

### INCORPORATION BY REFERENCE

This application claims priority to Japanese Patent Application No. 2022-155086 filed on Sep. 28, 2022, the entire contents of which are incorporated by reference herein.

### BACKGROUND

The present disclosure relates to a developing device contact and separation mechanism, and an image forming apparatus.

In existing tandem-type image forming apparatuses, a photoconductor drum is provided for each of toner colors. In the case where all developing rollers are made to rotate, in a monochrome printing operation of such an image forming apparatus, degradation of color toners may be accelerated, because of the rotation of the developing rollers for color printing. Accordingly, some image forming apparatuses are provided with a contact and separation mechanism that switches the contacting and separated state between the developing roller and the photoconductor drum, depending on the type of printing operation. The contact and separation mechanism allows only the developing roller for monochrome printing to contact the photoconductor drum, in the monochrome printing operation, but restricts the developing rollers for color printing from rotating.

### SUMMARY

The disclosure proposes further improvement of the foregoing techniques.

In an aspect, the disclosure provides a developing device contact and separation mechanism including a monochrome operating member, a color operating member, and a rotating member. The monochrome operating member causes a monochrome developing device to move between a contacting position, where the monochrome developing device is in contact with a monochrome photoconductor drum, and a separated position, where the monochrome developing device is spaced from the monochrome photoconductor drum. The color operating member causes a color developing device to move between the contacting position, where the color developing device is in contact with a color photoconductor drum, and a separated position, where the color developing device is spaced from the color photoconductor drum. The rotating member is made to rotate so as to assume one of a first rotational position for a non-operational state, a second rotational position for a color printing operation, and a third rotational position for a monochrome printing operation. At the first rotational position, the rotating member moves the monochrome developing device to the separated position, via the monochrome operating member, and moves the color developing device to the separated position, via the color operating member. At the second rotational position, the rotating member moves the monochrome developing device to the contacting position, via the monochrome operating member, and moves the color developing device to the contacting position, via the color operating member. At the third rotational position, the rotating member moves the monochrome developing device to the contacting position, via the monochrome operating member, and moves the color developing device to the separated position, via the color operating member.

In another aspect, the disclosure provides an image forming apparatus including the foregoing developing device contact and separation mechanism, and an image forming device that forms an image on a recording medium.

### BRIEF DESCRIPTION OF THE DRAWINGS

FIG. 1 is a schematic cross-sectional view showing an image forming apparatus according to an embodiment;

FIG. 2 is a perspective view showing a developing device contact and separation mechanism according to the embodiment;

FIG. 3 is an exploded perspective view of the developing device contact and separation mechanism according to the embodiment;

FIG. 4 is a side view for explaining an action of the developing device contact and separation mechanism according to the embodiment, in a non-operational state;

FIG. 5 is a side view for explaining an action of the developing device contact and separation mechanism according to the embodiment, in a color printing operation;

FIG. 6 is a side view for explaining an action of the developing device contact and separation mechanism according to the embodiment, in a monochrome printing operation;

FIG. 7 is a side view showing a contacting state of a developing device and a photoconductor drum, according to the embodiment;

FIG. 8 is a side view showing a spaced state of the developing device and the photoconductor drum, according to the embodiment; and

FIG. 9 is a side view for explaining an exemplary maintenance process for the image forming apparatus according to the embodiment.

### DETAILED DESCRIPTION

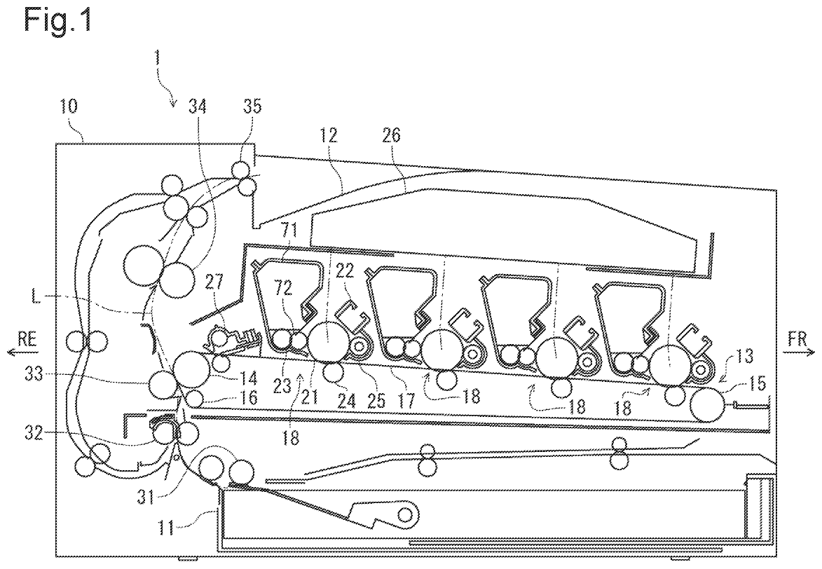

Hereafter, an image forming apparatus according to an embodiment of the disclosure will be described, with reference to the drawings. FIG. 1 is a schematic cross-sectional view showing the image forming apparatus according to the embodiment. In the following description, the image forming apparatus is exemplified by a printer. Reference codes FR and RE shown in each drawing indicate the front side and the rear side of the image forming apparatus. In addition, while a letter A accompanies the code of elements for monochrome printing, and a letter B accompanies the code of elements for color printing, such A or B may be omitted when the distinction between the monochrome printing and the color printing is unnecessary.

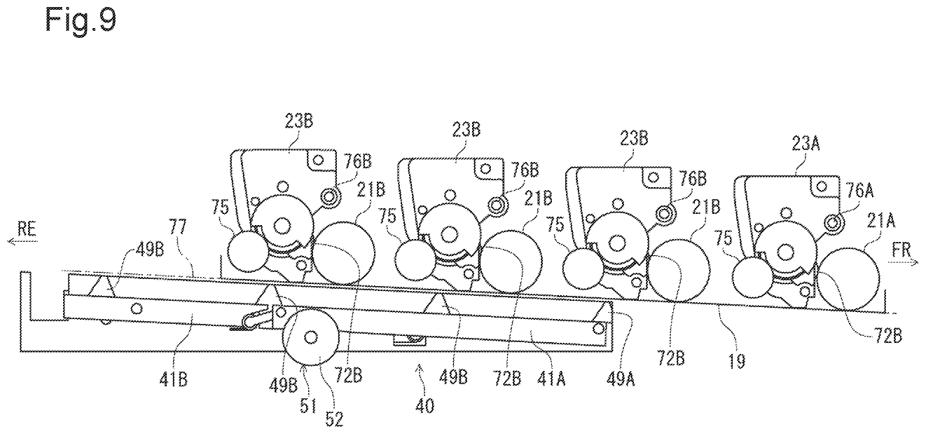

As shown in FIG. 1, the image forming apparatus 1 includes a box-shaped housing 10. In the lower section of the housing 10, a sheet cassette 11 for storing stacked sheets is provided, and an output tray 12 for delivering the sheets that have undergone the image forming operation is provided on the upper side of the housing 10. On the upper side of the sheet cassette 11, an intermediate transfer belt 17 is stretched around rollers 14, 15, and 16 of a transfer device 13. On the upper side of the intermediate transfer belt 17, a plurality of image forming units 18 are aligned, along the running direction of the intermediate transfer belt 17. The plurality of image forming units 18 are located on a single unit case 19 (see FIG. 9).

The image forming units 18 each include a photoconductor drum 21 that rotates in contact with the intermediate transfer belt 17. Around each of the photoconductor drums 21, a charging device 22, a developing device 23, a primary transfer roller 24, and a cleaning roller 25 are provided, in the order of a primary transfer process. For each developing device 23, a development housing 71 accommodating therein a toner of a predetermined color is provided. On the upper side of the image forming units 18, an exposure device 26 that emits a laser beam to the photoconductor drum 21 is provided. On the rear side of the image forming units 18, a cleaning device 27 that removes waste toner from the intermediate transfer belt 17 is provided.

In the rear section inside the housing 10, a transport route L is provided, to transport the sheet from the sheet cassette 11 to the output tray 12, with a plurality of rollers. A feeding roller 31 is provided at an upstream position (lower side) of the transport route L, and a resist roller 32 is provided on the transport route L, at a position downstream of the feeding roller 31. At a position downstream of the resist roller 32 on the transport route L, a secondary transfer roller 33 is provided, at the rear end of the intermediate transfer belt 17. A fixing roller 34 is provided on the transport route L at a position downstream of the secondary transfer roller 33, and a delivery roller 35 is provided at a downstream position (upper side) of the transport route L.

In the image forming operation by the image forming apparatus 1, the surface of the photoconductor drum 21 is electrically charged by the charging device 22, and an electrostatic latent image is formed on the surface of the photoconductor drum 21, by the laser beam from the exposure device 26. Then the toner from the developing device 23 is stuck to the electrostatic latent image on the surface of the photoconductor drum 21, so that a toner image is formed, and such toner image is transferred, as primary transfer, from the surface of the photoconductor drum 21 to the surface of the intermediate transfer belt 17. As result of the primary transfer of the toner images of the respective colors to the intermediate transfer belt 17 by the image forming units 18, a full-color toner image is formed on the surface of the intermediate transfer belt 17. The waste toner remaining on the photoconductor drum 21 is removed by a cleaning roller 25.

Meanwhile, the feeding roller 31 draws out the sheet from the sheet cassette 11, and the resist roller 32 delivers the sheet to the secondary transfer roller 33. The full-color toner image is transferred, as secondary transfer, from the surface of the intermediate transfer belt 17 to the surface of the sheet, by the secondary transfer roller 33, and the sheet to which the toner image has been transferred is transported to the fixing roller 34, located downstream of the secondary transfer roller 33. The toner image is fixed to the sheet by the fixing roller 34, and the sheet that has undergone the fixing process is delivered to the output tray 12, by the delivery roller 35. When the sheet with toner image thus passes the fixing roller 34, the image is formed on the surface of the sheet.

Here, the image forming apparatus 1 according to this embodiment is configured to perform both of color printing and monochrome printing. The developing rollers 72 of the respective developing devices 23 all have to be brought into contact with the corresponding photoconductor drum 21, in the color printing operation. In the case of the monochrome printing operation, however, the developing rollers 72 of the developing devices 23 other than the one involved in the monochrome printing do not have to be brought into contact with the photoconductor drum 21. Stopping the unused developing rollers 72 prevents the degradation of the toner, thereby extending the service life of the developing device 23. Further, while the intermediate transfer belt 17 is cleaned by the cleaning device 27 when the printing operation is finished, in this case all the developing rollers 72 have to be spaced from the corresponding photoconductor drum 21.

Accordingly, it is preferable to make each developing device 23 contact the photoconductor drum 21, or separate therefrom, depending on the type of the printing operation of the image forming apparatus 1. In the case where a complicated structure is adopted to allow the developing device 23 and the photoconductor drum 21 to move toward and away from each other, the manufacturing cost is increased, and besides a sufficient installation space has to be secured, which leads to an increase in overall size of the image forming apparatus 1. In the image forming apparatus 1 according to this embodiment, therefore, a developing device contact and separation mechanism 40, of an elongate shape in the front-back direction, is provided alongside the intermediate transfer belt 17, such that an increase in space can be minimized. In addition, the developing device contact and separation mechanism 40 is configured to move the developing device 23 and the photoconductor drum 21 toward and away from each other, with a simple structure that only employs a rotary cam and a pair of operating levers.

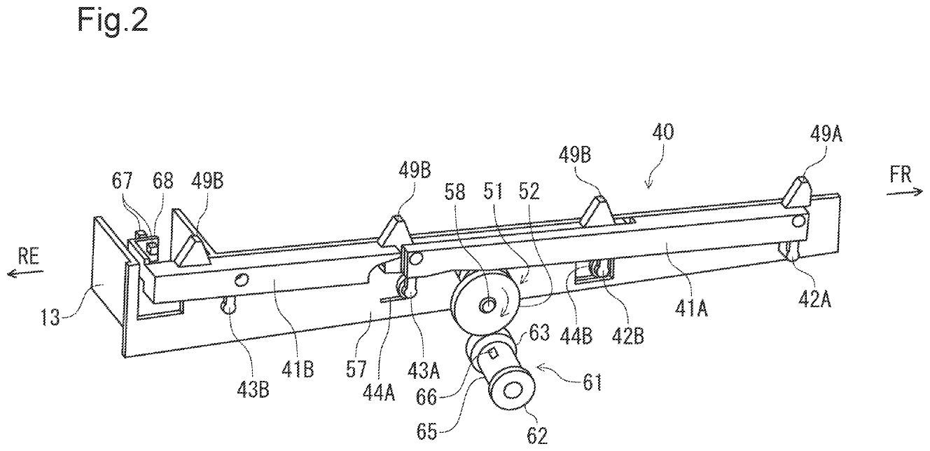

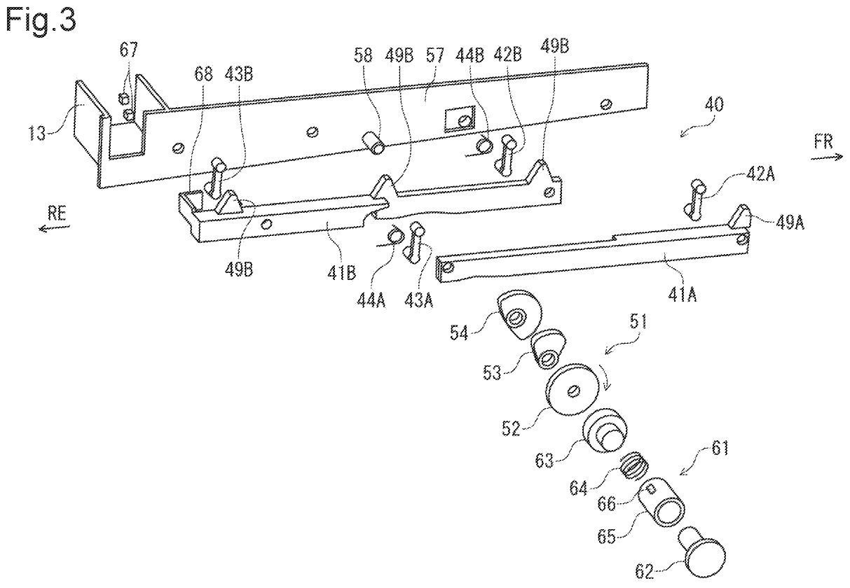

Referring to FIG. 2 and FIG. 3, the developing device contact and separation mechanism 40 will be described hereunder. FIG. 2 is a perspective view showing the developing device contact and separation mechanism according to this embodiment. FIG. 3 is an exploded perspective view of the developing device contact and separation mechanism according to this embodiment. In FIG. 2 and FIG. 3, only a sidewall of the transfer device supporting the intermediate transfer belt is illustrated.

As shown in FIG. 2 and FIG. 3, the developing device contact and separation mechanism 40 is mounted on the sidewall 57 of the transfer device 13. The developing device contact and separation mechanism 40 includes a monochrome operating lever (monochrome operating member) 41A and a color operating lever (color operating member) 41B. The monochrome operating lever 41A extends from the front end portion of the sidewall 57 to a middle portion thereof, and the color operating lever 41B extends from the middle portion of the sidewall 57 to the rear end portion thereof. The inner face of the rear portion of the monochrome operating lever 41A, and the outer face of the front portion of the color operating lever 41B are cut away in a stepped shape, so that the rear portion of the monochrome operating lever 41A and the front portion of the color operating lever 41B can overlap in the width direction.

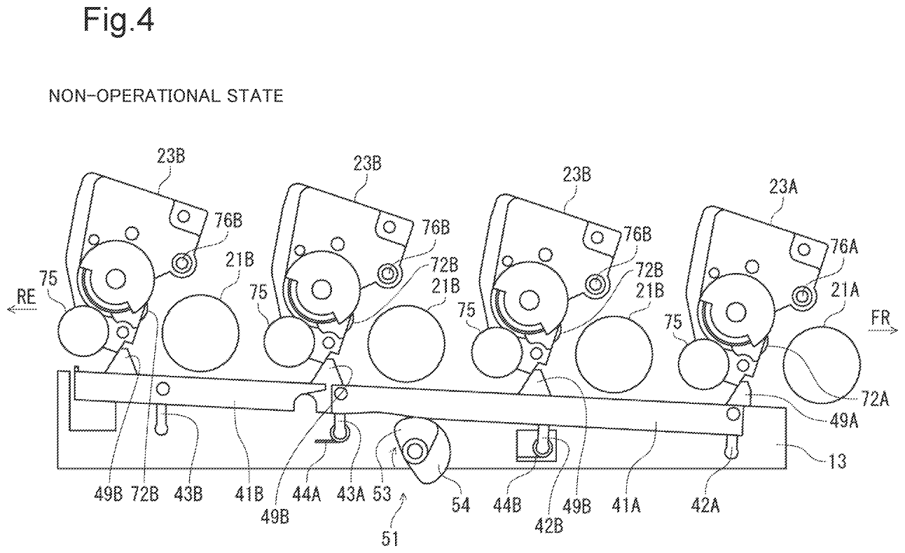

The front and rear end portions of the monochrome operating lever 41A are supported by the sidewall 57, via a pair of links 42A and 43A, respectively. The monochrome operating lever 41A, the sidewall 57, and the pair of links 42A and 43A constitute a parallel link mechanism, which allows the monochrome operating lever 41A to swing in the up-down direction, keeping a parallel posture. A torsion spring 44A is attached to the base portion of the rear-end link 43A of the monochrome operating lever 41A, so that the monochrome operating lever 41A is biased downward, by the spring force of the torsion spring 44A. A hill-shaped projection 49A is protruding upward from the front end portion of the monochrome operating lever 41A. The projection 49A serves to operate the developing device 23A for monochrome printing (see FIG. 4).

The front and rear end portions of the color operating lever 41B are supported by the sidewall 57, via a pair of links 42B and 43B, respectively. The color operating lever 41B, the sidewall 57, and the pair of links 42B and 43B constitute a parallel link mechanism, which allows the color operating lever 41B to swing in the up-down direction, keeping a parallel posture. A torsion spring 44B is attached to the base portion of the front-end link 42B of the color operating lever 41A, so that the color operating lever 41B is biased downward, by the spring force of the torsion spring 44B. Three hill-shaped projections 49B are protruding upward from the front end portion, the middle portion, and the rear end portion of the color operating lever 41B, respectively. These three projections 49B respectively serve to operate the three developing devices 23B for color printing (see FIG. 4).

Further, the developing device contact and separation mechanism 40 includes a rotating member 51 that moves the monochrome operating lever 41A and the color operating lever 41B. The rotating member 51 includes a rotary gear 52, a first cam 53, and a second cam 54, configured to rotate about a pin 58 sticking outward from the middle portion of the sidewall 57. The rotary gear 52 is located on the outer side, the first cam 53 at the center, and the second cam 54 on the inner side, such that the rotary gear 52, the first cam 53, and the second cam 54 rotate interlockedly. Motive power from a non-illustrated drive source is transmitted to the rotary gear 52, the first cam 53 is in contact with the monochrome operating lever 41A and the second cam 54 is in contact with the color operating lever 41B.

The first cam 53 and the second cam 54 are formed in a fan shape, the second cam 54 being larger in central angle, than the first cam 53. Assuming that the cams rotate clockwise, the first cam 53 overlaps with the rear-side portion of the second cam 54, in the rotating direction. The difference in central angle between the first cam 53 and the second cam 54 constitutes a two-stage cam that can individually move each of the monochrome operating lever 41A and the color operating lever 41B. Each time the rotating member 51 rotates by 120 degrees, the contacting position between the first cam 53 and the monochrome operating lever 41A, and the contacting position between the second cam 54 and the color operating lever 41B are switched.

The rotating member 51 is made to rotate among a first rotational position for a non operational state, a second rotational position for color printing, and a third rotational position for monochrome printing. At the first rotational position, the first cam 53 and the rear-side portion of the second cam 54 are located on the upper side. At the second rotational position, the first cam 53 and the second cam 54 are located on the lower side. At the third rotational position, the first cam 53 is located on the lower side and the front-side portion of the second cam 54 is located on the upper side. Owing to the rotation of the first cam 53 and the second cam 54, the monochrome operating lever 41A and the color operating lever 41B are made to move in the up-down direction. The contacting and separating actions of the plurality of developing devices 23A and 23B will be subsequently described in detail.

To the rotary gear 52, the motive power is transmitted from the drive source, via a spring clutch 61. Respective bosses of the input gear 62 and the output gear 63 of the spring clutch 61 are opposed to each other, and a coil spring 64 is fitted around the outer surfaces of the respective bosses, so as to fasten the bosses. The coil spring 61 is enclosed in a cylindrical clutch cover 65, an end portion of the coil spring 64 being fixed to the output gear 63, and the other end portion thereof being fixed to the clutch cover 65. Three small projections 66 are formed on the outer surface of the clutch cover 65 at regular intervals, and a non-illustrated nail to be engaged with the small projection 66 is provided at an end portion of a non-illustrated solenoid.

When the nail of the solenoid is disengaged from the small projection 66, the clutch cover 65 is released, so that the output gear 63 and the clutch cover 65 rotate interlockedly. Because of the fastening force of the coil spring 64, the motive power is transmitted from the input gear 62 to the output gear 63. When the nail of the solenoid is engaged with the small projection 66, the clutch cover 65 is restricted from rotating, so that the clutch cover 65 and the output gear 63 rotate relative to each other. Then the coil spring 64 is loosened, so that the transmission of the motive power from the input gear 62 to the output gear 63 is disconnected. The gear ratio between the output gear 63 and the rotary gear 52 is set to 1:3, and therefore the output gear 63 rotates once and the rotary gear 52 rotates by 120 degrees, each time the nail of the solenoid is disengaged.

A photosensor 67 that detects the color operating lever 41B is provided at the rear end portion of the sidewall 57 of the transfer device 13. The detects the color operating lever 41B, when the detection light from the photosensor 67 is blocked by a blocking plate 68 formed at the rear end of the color operating lever 41B. On the basis of combinations of the detection result from the photosensor 67 and the number of times of operation of the solenoid, the first to third rotational positions (for the non-operational state, color printing, and monochrome printing) of the rotating member 51 are distinguished. Here, the number of times of operation of the solenoid is reset at the third operation, in other words when the rotating member 51 has made one rotation. In addition, a reflective photosensor may be employed, without limitation to the photosensor 67 which is of a transmissive type.

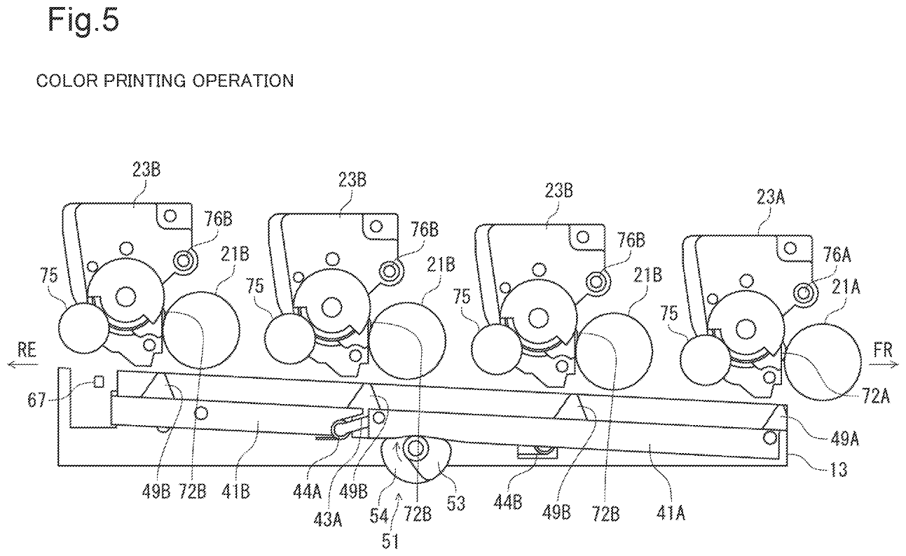

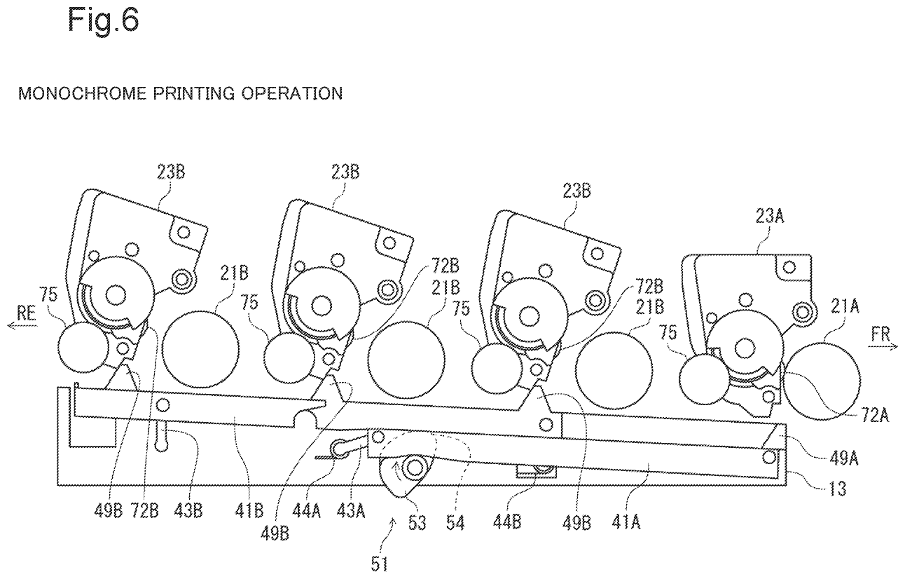

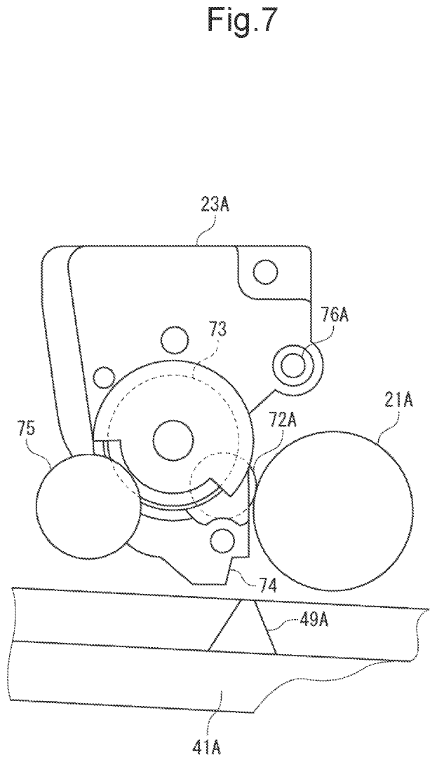

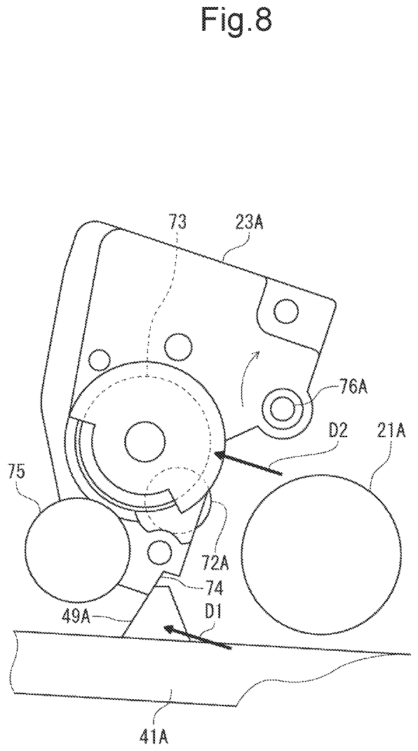

Referring to FIG. 4 to FIG. 9, the contacting and separating action of the developing device, realized by the developing device contact and separation mechanism 40 will be described hereunder. FIG. 4 is a side view for explaining the action of the developing device contact and separation mechanism according to this embodiment, in the non-operational state. FIG. 5 is a side view for explaining the action of the developing device contact and separation mechanism according to this embodiment, in the color printing operation. FIG. 6 is a side view for explaining the action of the developing device contact and separation mechanism according to the embodiment, in the monochrome printing operation. FIG. 7 is a side view showing a contacting state of the developing device and the photoconductor drum, according to this embodiment. FIG. 8 is a side view showing a spaced state of the developing device and the photoconductor drum, according to this embodiment. FIG. 9 is a side view for explaining an exemplary maintenance process for the image forming apparatus according to this embodiment.

As shown in FIG. 4, the developing device 23A for monochrome printing is located on the front end portion of the transfer device 13, and the three developing devices 23B for color printing are located on the rear side of the developing device 23A. The photoconductor drum 21A for monochrome printing is located adjacent to the developing device 23A, and three photoconductor drums 21B for color printing are located adjacent to the respective developing devices 23B. The developing devices 23A and 23B are slidable supported by supporting portions 76A and 76B of the unit case 19 (see FIG. 9), respectively. The developing devices 23A and 23B each include a non-illustrated spring, which is biasing each of the developing devices 23A and 23B toward the corresponding photoconductor drum 21A and 21B.

The monochrome operating lever 41A is located on the lower side of the developing device 23A, and the hill-shaped projection 49A is provided on the front end portion of the monochrome operating lever 41A, to operate the developing device 23A for monochrome printing. The color operating lever 41B is located on the lower side of the developing devices 23B, and the three hill-shaped projections 49B are provided on the rear end portion, the middle portion, and the front end portion of the color operating lever 41B, respectively, to operate the three developing devices 23B for color printing. The monochrome operating lever 41A is biased toward the first cam 53 by the spring force of the torsion spring 44A, and the color operating lever 41B is biased toward the second cam 54 by the spring force of the torsion spring 44B.

Because of the rotation of the rotating member 51 by 120 degrees, realized each time the solenoid is driven, the monochrome operating lever 41A is moved by the first cam 53, and the color operating lever 41B is moved by the second cam 54. The monochrome operating lever 41A moves the developing device 23A, via the projection 49A, between the contacting position of being in contact with the photoconductor drum 21A, and the separated position of being spaced from the photoconductor drum 21A. The color operating lever 41B moves the three developing devices 23B, via the respective projections 49B, between the contacting position of being in contact with the corresponding photoconductor drum 21B, and the separated position of being spaced from the corresponding photoconductor drum 21B.

In the non-operational state, the rotating member 51 stays at the first rotational position. In the first rotational position, the first cam 53 is located on the upper side, and the rear-side portion of the second cam 54 is located on the upper side. The monochrome operating lever 41A is lifted up by the first cam 53 against the spring force of the torsion spring 44A, and the color operating lever 41B is lifted up by the rear-side portion of the second cam 54, against the spring force of the torsion spring 44B. The developing device 23A is moved to the separated position by the projection 49A of the monochrome operating lever 41A, and each of the developing devices 23B is moved to the separated position, by the corresponding projection 49B of the color operating lever 41B.

Thus, in the first rotational position, the first cam 53 causes the developing device 23A to move to the separated position, via the monochrome operating lever 41A, and the second cam 54 causes the developing devices 23B to move to the separated position, via the color operating lever 41B. Since the developing devices 23A and 23B are separated from the corresponding photoconductor drums 21A and 21B, the developing rollers 72A and 72B are kept from being made to rotate by the corresponding photoconductor drums 21A and 21B, during the cleaning operation. Therefore, the degradation of the toner in the developing devices 23A and 23B can be prevented. When the developing devices 23A and 23B are at the separated position, the transmission of the driving force from the drive source to the developing rollers 72A and 72B is also disconnected.

Proceeding to FIG. 5, in the color printing operation, the rotating member 51 is made to rotate clockwise by 120 degrees, and stopped at the second rotational position. At the second rotational position, the first cam 53 is located at the lower side, and the second cam 54 is located on the lower side. The monochrome operating lever 41A is pressed downward by the spring force of the torsion spring 44& and the color operating lever 418 is pressed downward by the spring force of the torsion spring 44B. The projection 49A of the monochrome operating lever 41A is separated from the developing device 23A so that the developing device 23A is moved to the contacting position, and each of the projections 49B of the color operating lever 41B is separated from the developing device 23B, so that the developing devices 23B are moved to the contacting position.

Thus, in the second rotational position, the first cam 53 causes the developing device 23A to move to the contacting position, via the monochrome operating lever 41A and the second cam 54 causes the developing devices 23B to move to the contacting position, via the color operating lever 41B. Since the developing devices 23A and 23B are in contact with the corresponding photoconductor drums 21A and 21B, the toner is supplied from the developing rollers 72A and 72B to the corresponding photoconductor drums 21A and 21B, so that the color printing is performed on the sheet. When the developing devices 23A and 23B are at the contacting position, the driving force from the drive source is transmitted to the developing rollers 72A and 72B.

Proceeding to FIG. 6, in the monochrome printing operation, the rotating member 51 is made to further rotate clockwise by 120 degrees, and stopped at the third rotational position. At the third rotational position, the first cam 53 is located at the lower side, and the front-side portion of the second cam 54 is located on the upper side. The monochrome operating lever 41A continues to be pressed down by the first cam 53, and the color operating lever 41B is lifted up by the front-side portion of the second cam 54, against the spring force of the torsion spring 44B. The developing device 23A remains at the contacting position, while the developing devices 23B are moved to the separated position, by the corresponding projections 49B of the color operating lever 41B.

Thus, in the third rotational position, the first cam 53 causes the developing device 23A to move to the contacting position, via the monochrome operating lever 41A, and the second cam 54 causes the developing devices 23B to move to the separated position, via the color operating lever 41B. Since the developing devices 23B are separated from the corresponding photoconductor drums 21B, the developing rollers 72B are kept from being made to rotate by the corresponding photoconductor drums 21B, during the monochrome printing operation. Therefore, the degradation of the toner in the developing devices 23B can be prevented. Further, since the developing device 23A is at the contacting position, and the developing devices 23B are at the separated position, the driving force from the drive source is transmitted only to the developing roller 72A.

As described above, the rotational positions of the rotating member 51 are distinguished, on the basis of the combinations of the detection result from the photosensor 67 and the number of times of operation of the solenoid. When the color operating lever 41B is detected by the photosensor 67, and the solenoid has operated once, the rotating member 51 is decided to be at the first rotational position (see FIG. 4). When the color operating lever 41B is not detected by the photosensor 67, and the solenoid has operated twice, the rotating member 51 is decided to be at the second rotational position (see FIG. 5). When the color operating lever 41B is detected by the photosensor 67, and the solenoid has operated three times, the rotating member 51 is decided to be at the third rotational position (see FIG. 6).

Referring to FIG. 7, the developing device 23A includes a driving gear 73 that causes the developing roller 72 to rotate. The projection 49A of the monochrome operating lever 41A is spaced from an engaging portion 74 formed at the lower end of the developing device 23A, and the developing device 23A is located at the contacting position, such that the developing roller 72A is in contact with the photoconductor drum 21A. When the developing device 23A is at the contacting position, the driving gear 73 of the developing device 23A is meshed with a transmission gear 75 of the non-illustrated drive source. When the photoconductor drum 21A enters into contact with the developing roller 72A, and the motive power from the drive source is transmitted to the developing roller 72A via the transmission gear 75 and the driving gear 73, the developing roller 72A is made to rotate.

Proceeding to FIG. 8, the projection 49A of the monochrome operating lever 41A is abutted against the engaging portion 74 formed at the lower end of the developing device 23A, and the developing device 23A is made to move about the supporting portion 76A to the separated position, so that the developing roller 72A is separated from the photoconductor drum 21A. When the developing device 23A is at the separated position, the driving gear 73 of the developing device 23A is disengaged from the transmission gear 75 of the drive source. Since the developing roller 72A is spaced from the photoconductor drum 21A, and the motive power from the drive source to the developing device 23A is disconnected, the developing roller 72A is unable to be made to rotate, by the motive power from the photoconductor drum 21A or the drive source.

With the configuration described above, the photoconductor drum 21A and the developing device 23A can be made to move toward or away from each other, by the action of the monochrome operating lever 41A and the motive power to the developing device 23A can be transmitted and disconnected. In addition, an operation direction D1 of the monochrome operating lever 41A is set to be parallel to the contact and separation direction D2 between the photoconductor drum 21A and the developing device 23A. Therefore, the developing device 23A can be smoothly moved to the separated position, by the monochrome operating lever 41A. Here, although the contacting and separating action has been described with respect to the developing device 23A and the photoconductor drum 21A the same description is also applicable to the contacting and separating action between the developing device 23B and the photoconductor drum 21B.

Referring to FIG. 9, the developing device 23A for monochrome printing, developing three devices 23B for color printing, the photoconductor drum 21A for monochrome printing, and the three photoconductor drums 21B for color printing are mounted on the unit case 19. For maintenance work, like in the case of color printing, the color operating lever 41B and the monochrome operating lever 41A are lowered, so that the projections 49A and 49B are located on the lower side of the developing devices 23A and 23B. The unit case 19 is drawn out to the front side from the housing 10, and a drawout trajectory 77, parallel to the extending direction of the color operating lever 41B and the monochrome operating lever 41A in a side view, is defined by the lower face of the unit case 19.

Thus, the color operating lever 41B and the monochrome operating lever 41A are also lowered for the maintenance work, as in the color printing operation, despite that the image forming apparatus 1 is in the non-operational state. When the developing devices 23A and 23B are set to the contacting position by the monochrome operating lever 41A and the color operating lever 41B, the monochrome operating lever 41A and the color operating lever 41B are deviated from the drawout trajectory 77 of the unit case 19. Therefore, when the maintenance work is to be done for the components mounted on the unit case 19, the monochrome operating lever 41A and the color operating lever 41B are kept from interfering the drawout action of the unit case 19.

Now, with a contact and separation mechanism that moves the developing roller and the photoconductor drum toward and away from each other, with a back and forth movement of a translating cam unlike in this embodiment, a sufficient installation space for the contact and separation mechanism may be unable to be secured, depending on the structure of the image forming apparatus.

According to this embodiment, in contrast, the developing devices 23A and 23B are separated from the corresponding photoconductor drums 21, by the monochrome operating lever 41A and the color operating lever 41B, in the non-operational state. In the color printing operation, the developing devices 23A and 23B are brought into contact with the photoconductor drums 21A and 21B, by the monochrome operating lever 41A and the color operating lever 41B. In the monochrome printing operation, the developing devices 23B are spaced from the respective photoconductor drums 21B for color printing, by the color operating lever 41B. Thus, the developing devices 23, which are not used in the monochrome printing operation and the non-operational state, are kept from being made to rotate by the photoconductor drum 21, and therefore the degradation of the toner in the developing device 23 can be prevented. In addition, the structure of the developing device contact and separation mechanism 40 can minimize an increase in installation space, thereby preventing an increase in overall size of the image forming apparatus 1.

Although the monochrome operating member and the color operating member are exemplified by the monochrome operating lever 41A and the color operating lever 41B respectively, in the foregoing embodiment, the shape of the monochrome operating member and the color operating member is not limited to the lever shape. It suffices that the monochrome operating member is capable of moving the developing device for monochrome printing between the contacting position and the separated position, and that the color operating member is capable of moving the developing device for color printing between the contacting position and the separated position.

Although the rotating member 51 includes the fan-shaped first cam 53 and second cam 54 in the foregoing embodiment, the shape of the rotating member 51 is not specifically limited. It suffices that the rotating member 51 is capable of moving the developing device, via the monochrome operating member and the color operating member.

According to the foregoing embodiment, the motive power from the drive source to the developing device is transmitted or disconnected, by the engaging and disengaging action between the driving gear of the developing device and the transmission gear of the drive source. However, the switching method between the transmission and the disconnection of the motive power from the drive source to the developing device is not specifically limited.

According to the foregoing embodiment, the operation direction of the monochrome operating member and the color operating member is parallel to the contacting and separating direction between the photoconductor drum and the developing device. However, it is not mandatory that the operation direction of the monochrome operating member and the color operating member is parallel to the contacting and separating direction between the photoconductor drum and the developing device.

Further, the image forming apparatus 1 is exemplified by the printer in the foregoing embodiment, the disclosure is not limited to such embodiment. The image forming apparatus 1 may be, for example, a copier, a facsimile machine, or a multifunction peripheral having a plurality of functions such as printing, copying, and facsimile transmission.

According to the disclosure, the developing devices are separated from the corresponding photoconductor drums via the operating member, in the non-operational state. In the color printing operation, the developing devices are brought into contact with the corresponding photoconductor drums via the operating members. In the monochrome printing operation, the color developing devices are separated from the corresponding color photoconductor drums, via the color operating member. Accordingly, the developing devices which are not used in the monochrome printing operation and the non-operational state, are kept from being made to rotate by the photoconductor drum, and therefore the degradation of the toner in the developing device can be prevented. In addition, the structure of the developing device contact and separation mechanism can minimize an increase in installation space, thereby preventing an increase in overall size of the image forming apparatus.

Although the disclosure has been described on the basis of the foregoing embodiment, the embodiment and a variation thereof may be partially or entirely combined, as another embodiment.

The techniques of the disclosure is not limited to those employed in the foregoing embodiment, but may be changed, substituted, or modified in various manners, without departing from the scope of the technical idea of the disclosure. Further, in the case where the technical idea can be realized by another method, owing to a progress of technology or by another derivative technique, the disclosure may be realized by such another method. Therefore, the appended claims encompass all implementations that may be included in the scope of the technical idea.

While the present disclosure has been described in detail with reference to the embodiments thereof, it would be apparent to those skilled in the art the various changes and modifications may be made therein within the scope defined by the appended claims.

What is claimed is:

1. A developing device contact and separation mechanism comprising:
a monochrome operating member that causes a monochrome developing device to move between a contacting position, where the monochrome developing device is in contact with a monochrome photoconductor drum, and a separated position, where the monochrome developing device is spaced from the monochrome photoconductor drum;
a color operating member that causes a color developing device to move between the contacting position, where the color developing device is in contact with a color photoconductor drum, and a separated position, where the color developing device is spaced from the color photoconductor drum; and
a rotating member to be made to rotate so as to assume one of a first rotational position for a non-operational state, a second rotational position for a color printing operation, and a third rotational position for a monochrome printing operation,
wherein, at the first rotational position, the rotating member moves the monochrome developing device to the separated position, via the monochrome operating member, and moves the color developing device to the separated position, via the color operating member,
at the second rotational position, the rotating member moves the monochrome developing device to the contacting position, via the monochrome operating member, and moves the color developing device to the contacting position, via the color operating member, and
at the third rotational position, the rotating member moves the monochrome developing device to the contacting position, via the monochrome operating member, and moves the color developing device to the separated position, via the color operating member.

2. The developing device contact and separation mechanism according to claim 1,
wherein the rotating member includes a first cam that contacts the monochrome operating member, and a second cam that contacts the color operating member,
in the first rotational position, the first cam moves the monochrome developing device to the separated position via the monochrome operating member, and the second cam moves the color developing device to the separated position via the color operating member,
in the second rotational position, the first cam moves the monochrome developing device to the contacting position via the monochrome operating member, and the second cam moves the color developing device to the contacting position via the color operating member, and
in the third rotational position, the first cam moves the monochrome developing device to the contacting position, via the monochrome operating member, and the second cam moves the color developing device to the separated position, via the color operating member.

3. The developing device contact and separation mechanism according to claim 1,
wherein, in the contacting position, motive power is transmitted from a drive source to the monochrome developing device and the color developing device, and
in the separated position, the power source from the drive source to the monochrome developing device and the color developing device is disconnected.

4. The developing device contact and separation mechanism according to claim 1,
wherein an operation direction of the monochrome operating member is parallel to a contacting and separating direction between the monochrome photoconductor drum and the monochrome developing device, and
an operation direction of the color operating member is parallel to a contacting and separating direction between the color photoconductor drum and the color developing device.

5. The developing device contact and separation mechanism according to claim 1,
wherein the monochrome photoconductor drum, the monochrome developing device, the color photoconductor drum, and the color developing device are mounted on a single case, and
when the monochrome developing device is moved to the contacting position by the monochrome operating member, and the color developing device is moved to the contacting position by the color operating member, the monochrome operating member and the color operating member are deviated from a drawout trajectory defined by a lower face of the case.

6. The developing device contact and separation mechanism according to claim 1,
wherein a parallel link mechanism that allows each of the monochrome operating member and the color operating member to swing in an up-down direction, keeping a parallel posture, is provided, with a front end portion and a rear end portion of the monochrome operating member being supported by a sidewall of a transfer device, via a pair of links respectively, and a front and portion and a rear end portion of the color operating member being supported by the sidewall of the transfer device, via a pair of links respectively.

7. An image forming apparatus comprising:
the developing device contact and separation mechanism according to claim 1; and
an image forming device that forms an image on a recording medium.
